(19) United States
(12) Patent Application Publication
(10) Pub. No.: US 2020/0030166 A1
(43) Pub. Date: Jan. 30, 2020

(54) WHEELCHAIR SECURING SYSTEM FOR A PASSENGER VEHICLE

(71) Applicant: GM GLOBAL TECHNOLOGY OPERATIONS LLC, Detroit, MI (US)

(72) Inventor: Wade W. Bryant, Grosse Pointe Farms, MI (US)

(21) Appl. No.: 16/046,383

(22) Filed: Jul. 26, 2018

(51) Int. Cl. A61G 3/08

(52) U.S. Cl. CPC A61G 3/0808

(57) ABSTRACT

A wheelchair securing system for a passenger vehicle includes a first lateral barrier positioned on one side of a wheelchair receiving area of the passenger vehicle and a second lateral barrier positioned on an opposing side of the wheelchair receiving area. Each of the first and second lateral barriers are adapted to compressively engage a wheelchair between them and the first lateral barrier includes a plurality of fingers extending from a surface of the first lateral barrier toward the wheelchair receiving area.

### FIELD

The present disclosure relates to a wheelchair securing system for a passenger vehicle.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

There is a well-recognized need to provide access to mobility services for physically challenged passengers. Many physically challenged passengers travel in a wheelchair and there is a need to provide accommodations for wheelchairs in mobility services. There are many existing systems and methods for securing a wheelchair in a vehicle. However, these systems have many challenges. Many of these systems require the assistance of another passenger and/or driver of a vehicle to manually secure the wheelchair in the vehicle. Not only does this increase the workload of the mobility service, but this may result in unwanted contact between the person occupying the wheelchair and the person who is assisting. It is desirable to provide wheelchair securing system which reduces and/or eliminates the requirement for assistance from others in securing the wheelchair within the vehicle.

Additionally, many of the existing wheelchair securing systems may be designed for large public transportation vehicles. In general, passenger safety systems in large public transport vehicles may be reduced below that which is generally preferred of smaller, private or semi-private (and perhaps shared) vehicles. This approach is taken because it is assumed that large public transport vehicles are less likely to experience high deceleration forces. Therefore, the wheelchair securing systems which have been designed for use in these large public transportation vehicles may not be sufficient for other types of vehicles. It is desirable to improve the ability of wheelchair securing systems to securely maintain the position of a wheelchair within a vehicle, regardless of the type of vehicle.

Other wheelchair securing systems which may be designed for a wider range of vehicles may require modification of a wheelchair and/or the vehicle in which the wheelchair is intended to be transported. Specialized wheelchair and vehicle modifications may be acceptable for a vehicle which may be personal to the owner of the wheelchair and vehicle, however, such systems are not practical for vehicles that may be shared. There is a need to provide a wheelchair securing system that does not require modification of a wheelchair and which may be used with wheelchairs having a wide variety of configurations.

Another challenge with existing wheelchair securing systems for passenger vehicles is the ability to accommodate a wide variety of wheelchair configurations while ensuring that the wheelchair is adequately secured within the vehicles. As explained above, large vehicles that may be used in public transportation systems may include wheelchair securing systems which may accommodate a wide variety of wheelchair configurations, however, those systems have a limited ability to secure the wheelchair when exposed to potentially higher deceleration forces. Especially those deceleration forces that may be experienced by smaller, non-public transportation services and vehicles. A need exists to improve the capability to secure a wide variety of and differing configurations of wheelchairs within a wider variety of vehicles and transportation services.

### SUMMARY

In an exemplary aspect, a wheelchair securing system for a passenger vehicle includes a first lateral barrier positioned on one side of a wheelchair receiving area of the passenger vehicle and a second lateral barrier positioned on an opposing side of the wheelchair receiving area. Each of the first and second lateral barriers are adapted to compressively engage a wheelchair between them and the first lateral barrier includes a plurality of fingers extending from a surface of the first lateral barrier toward the wheelchair receiving area.

In this manner, a wheelchair securing system is provided which not only improves the ability to secure the wheelchair in a vehicle, but which is also flexibly adaptable to wheelchairs of any shape and/or configuration.

In another exemplary aspect, one of the plurality of fingers adaptively configure the distance that the one of the plurality of fingers extends from the surface of the first lateral barrier.

In another exemplary aspect, the distance that the one of the plurality of fingers extends from the surface of the first lateral barrier is responsive to contact with a wheelchair.

In another exemplary aspect, the one of the plurality of fingers reduces the extent that the one of the plurality of fingers extends from the surface of the first lateral barrier in response to contact with the wheelchair.

In another exemplary aspect, another one of the plurality of fingers maintains the extent that the another one of the plurality of fingers extends from the surface of the first lateral barrier in response to an absence of contact with the wheelchair.

In another exemplary aspect, the first lateral barrier includes an arm body defining a cavity adapted to slidably receive the one of the plurality of fingers.

In another exemplary aspect, the system further includes a spring in the cavity biasing the one of the plurality of fingers to extend out of the surface of the first lateral barrier.

In another exemplary aspect, the arm body further includes an orifice at the surface having a smaller diameter than a diameter of the cavity.

In another exemplary aspect, the one of the plurality of fingers includes a protrusion and a cylindrical base.

In another exemplary aspect, the diameter of the orifice is smaller than a diameter of the cylindrical base and is larger than a diameter of the protrusion.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of an exemplary wheelchair securing system in a vehicle;

FIG. 2 is a partial perspective view of the wheelchair securing system of FIG. 1;

FIG. 3A illustrates a perspective view of an exemplary wheelchair securing system in a first configuration;

FIG. 3B illustrates a perspective view of the wheelchair securing system of FIG. 3A in a second configuration;

FIG. 3C illustrates a perspective view of the wheelchair securing system of FIG. 3A in a third configuration;

FIG. 4 is a partial cut-away view of a portion of an arm of a wheelchair securing system;

FIG. 5 is a partial perspective view of a portion of a wheelchair securing system;

FIG. 6 is another partial perspective view of the portion of the wheelchair securing system of FIG. 5;

FIG. 7 is a partial perspective view of arm rotation system components of the wheelchair securing system of FIG. 5;

FIG. 8 is a partial perspective view of components of the wheelchair securing system of FIG. 5;

FIG. 9 is a partial perspective view of arm extension system components of the wheelchair securing system of FIG. 5; and

FIG. 10 is another partial perspective view of components of the wheelchair securing system of FIG. 5.

### DETAILED DESCRIPTION

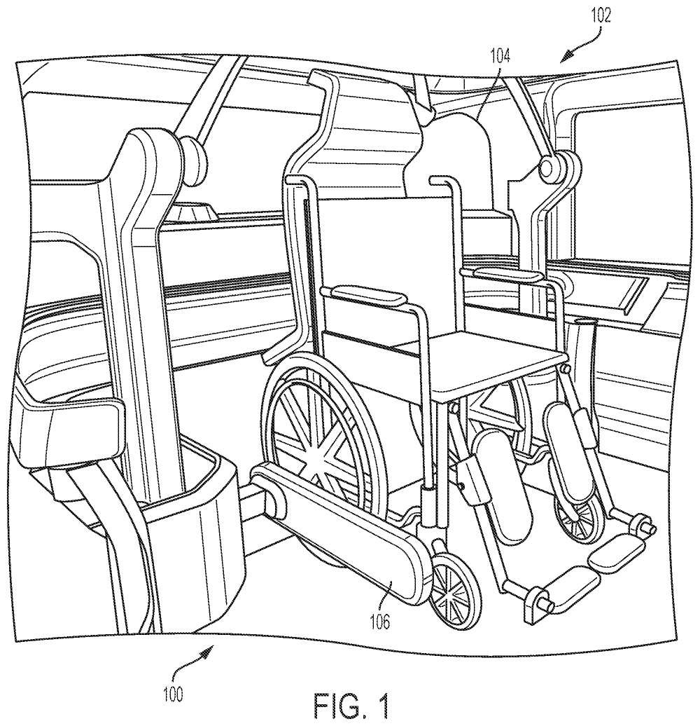

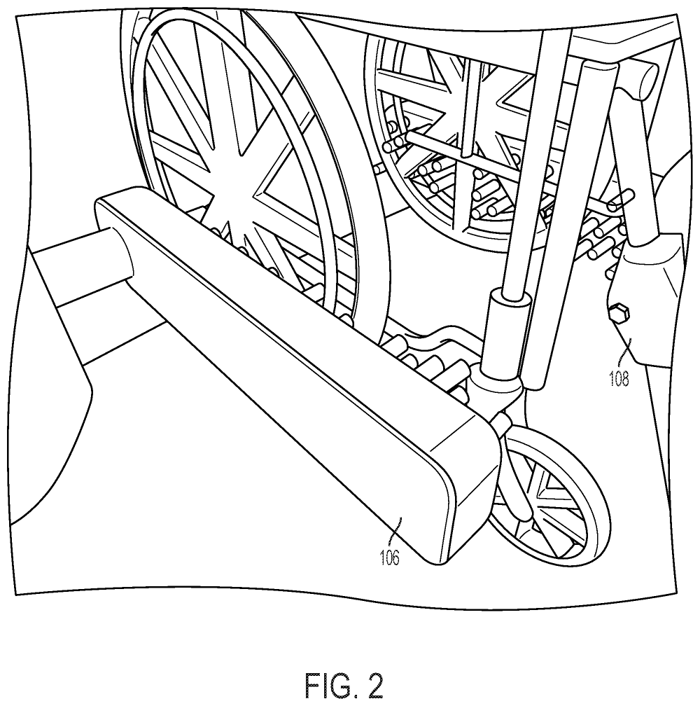

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures, FIG. 1 is a is a perspective view of an exemplary wheelchair securing system 100 in a vehicle 102. The exemplary wheelchair securing system 100 operates to secure a wheelchair 104 in position within a passenger compartment of a vehicle 102. The system 100 includes a pair of arms 106 which, when deployed, capture the wheelchair 104 between them and apply force laterally to the sides of the wheelchair 104 to secure the wheelchair 104 between the arms 106. In this manner, each of the pair of arms 106 may act as barrier against lateral movement of the wheelchair within the vehicle and, thus, may also be referred to as a lateral barrier. Each of the pair of arms 106 further include a plurality of fingers 108 (see FIG. 2) which each independently interact with the wheelchair 104. Those fingers 108 which come into contact with the wheelchair 104 compress into the respective arm 106 while those fingers 108 which do not contact any portion of the wheelchair 104 may maintain their fully extended configuration or a partially extended configuration. In this manner, each of the plurality of fingers 108 automatically and flexibly adapt to the configuration of the wheelchair 104, thereby further enhancing the security of the wheelchair in maintaining its position within the vehicle regardless of the configuration of the wheelchair. As will be further explained, each of the plurality of fingers 108 separately and independently conform to the shape of the wheelchair 104 which enhances the ability of the arms 106 to maintain the position of the wheelchair 104 in the vehicle 102, especially with respect to the longitudinal and vertical axes of the vehicle/wheelchair.

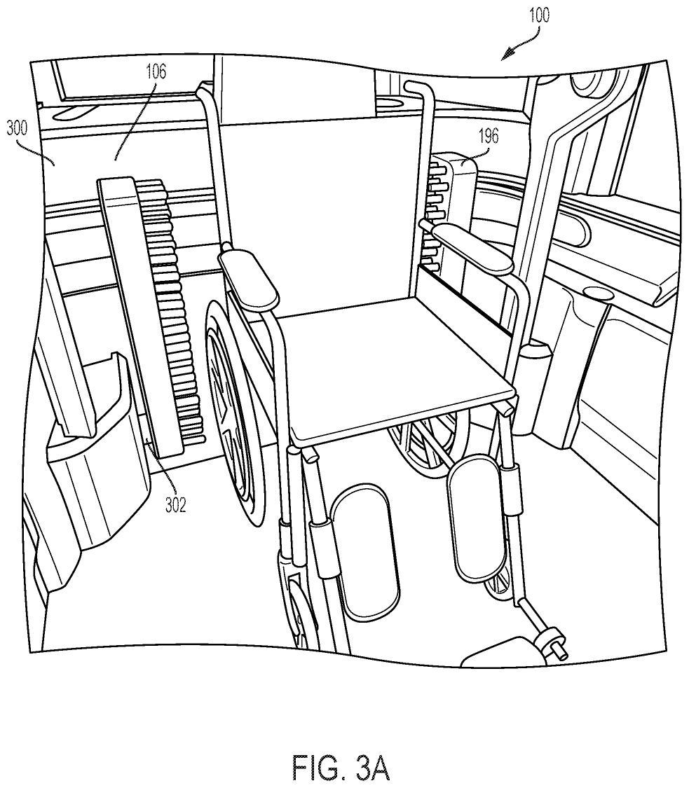

Operation of an exemplary embodiment of the wheelchair securing system 100 will now be explained with reference to FIGS. 3A through 3C. FIG. 3A illustrates an initial configuration of the system 100 in which the arms 106 are positioned in a vertical orientation adjacent a back surface 300 of the vehicle 102. Each of the arms 106 is pivotally attached to the vehicle 102 via an extendible and rotatable shaft 302. In this configuration, a passenger may position their wheelchair 104 in an appropriate location for interacting with the wheelchair securing system 100. Once the passenger has positioned the wheelchair 104 in an appropriate location, the passenger may then initiate operation of the wheelchair securing system 100. The initiation of operation of the wheelchair securing system 100 may be accomplished via any number or variety of known initiation systems, such as, for example, a button (not shown) that may be depressed by the passenger to initiate operation. The manner of initiation of such systems is well known and the wheelchair securing system of the present disclosure may operate using any of these systems without limitation.

In response to initiation, the arms 106 of the wheelchair securing system 100 may pivot from their vertical orientation to a substantially horizontal orientation in which the pair of arms 106 are positioned on opposing sides of the wheelchair 104. In this configuration, the plurality of fingers 108 on each of the respective arms 106 fully extend from the surfaces of the arms that face the sides of the wheelchair 104. Next, each of the pair of arms 106 extend inwardly into the passenger compartment of the vehicle until each of the arms 106 applies a predetermined amount of force to the sides of the wheelchair 104. The amount of force applied by the arms 106 to the sides of the wheelchair 104 may be calibrated and/or adapted as is known in the art. The amount of force should not be too high that it might risk damaging a wheelchair, but it should be sufficient to provide enough holding force to maintain the wheelchair in position along a lateral axis within the vehicle. In contrast to conventional wheelchair securing systems which have only been able to rely upon this compressive force on the side of the wheelchair to provide sufficient grip of the wheelchair such that the wheelchair is held in position, the plurality of fingers 108 on each arm provide the possibility to reduce the clamping force applied by the arms on the wheelchair. In this manner, the risk of damage to a wheelchair may be reduced and/or eliminated while simultaneously improving the ability of the system 100 to hold the wheelchair in position within the vehicle as a result of the fingers on each of the arms.

While the present disclosure illustrates and describes wheelchair securing systems which may include a pair of movable arms configured to engage opposing sides of a wheelchair, it is understood that an exemplary embodiment of the wheelchair securing system may include only a single movable arm that is configured to engage one side of a wheelchair while a stationary surface may engage an opposing surface of the wheelchair.

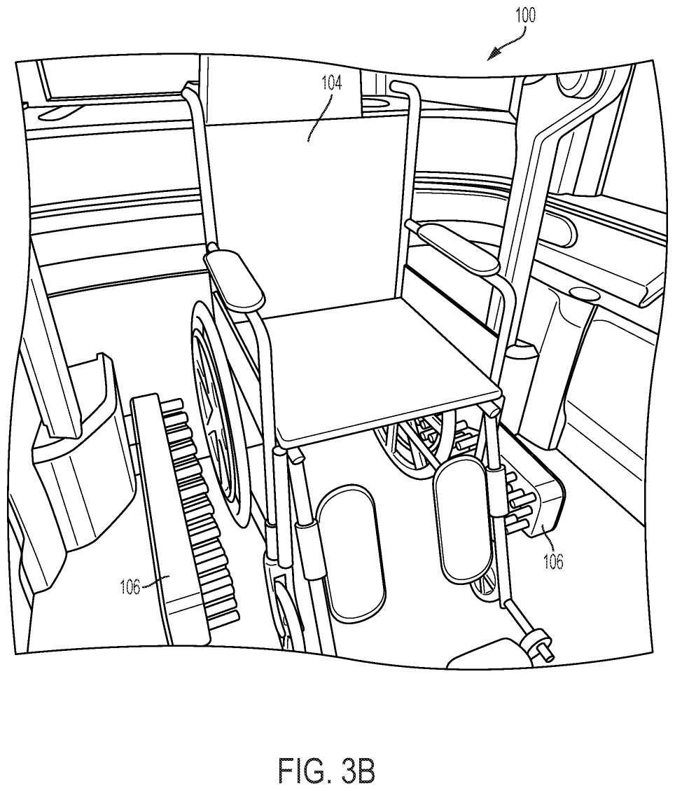

FIG. 4 illustrates a cut-away view of a portion of an arm 400 for a wheelchair securing system in accordance with an exemplary embodiment of the present disclosure. The arm 400 includes a wheelchair facing surface 402 which, when deployed, faces and comes into contact with a side of a wheelchair which is being secured by the wheelchair securing system. As explained previously, the arm 400 may be attached by a shaft 404 which is pivotally and extendibly attached to a vehicle in which the wheelchair (not shown) is to be secured. The arm 400 includes an arm body 406 mounted on a backing plate 408 which supports the arm body 406. The backing plate 408 may provide support for the arm body 406 and connect the arm 400 to the shaft 404. In an exemplary embodiment, the arm body 406 may be formed from an elastic and compressible material such that the surface 402 at least slightly conforms to and grips the sides of the wheelchair with which it contacts when securing a wheelchair within the vehicle. The arm body 406 may further include a plurality of cavities 410 which are each adapted to receive at least a portion of one of the plurality of fingers 412.

Each of the plurality of fingers 412 in the exemplary embodiment of FIG. 4 is comprised of a pin 414, a spring 416, and a finger 418. The pin 414 may be attached at a proximal end to the backing plate 408. A distal end of the pin 414 may be slidably received within an internal cavity 420 defined within the finger 418. The pin 404 further includes a cylindrical base 422 and a protrusion 424. The cylindrical base 424 has an outer diameter which is a small amount less than the inner diameter of the cavity 410 in which the cylindrical base 424 is positioned such that the cylindrical base 424 may be slidably received within the cylindrical base 424. Each cavity 410 within the arm body 406 includes an orifice 426 which has a diameter that is less than the diameter of the cylindrical base 424 and larger than the diameter of the protrusion 424 of the finger 412. In this manner, the protrusion 424 may extend through the orifice 426. The spring 416 is captured within the cavity 410 between the backing plate 408 and the finger 418 such that the spring biases the finger 418 away from the backing plate 408 and into a configuration where the protrusion 424 extends through the orifice 426 and protrudes beyond the surface 402 of the arm body 406. While the present description describes a specific exemplary embodiment of an arm having a plurality of fingers, it is to be understood that the present invention is intended to encompass any wheelchair securing system having arms with a plurality of fingers, and, more particularly, extendible fingers, regardless of the structure or configuration of the plurality of extendible fingers without limitation.

In operation, and as explained previously, when the arm 400 moves inwardly toward the wheelchair, in a manner similar to the transition between the configuration of FIGS. 3B and 3C, when any one of the plurality of fingers 412 contacts a surface of the wheelchair, as the arm continues to move toward the wheelchair and applies a force to the wheelchair side, the fingers 412 in contact with the wheelchair are pushed into the arm body 406 against the bias of the spring 416. Those fingers which do not contact a surface of the wheelchair remain fully extended, or they may vary in the amount they extend from the arm body 406 depending upon the specific configuration of the wheelchair being secured. The fingers which are not retracted or which may be partially retracted serve as a barrier against longitudinal and/or vertical movement of the wheelchair within the wheelchair securing system. In this manner, the wheelchair securing system of the present disclosure improves the ability of the system to maintain the wheelchair in position within the vehicle.

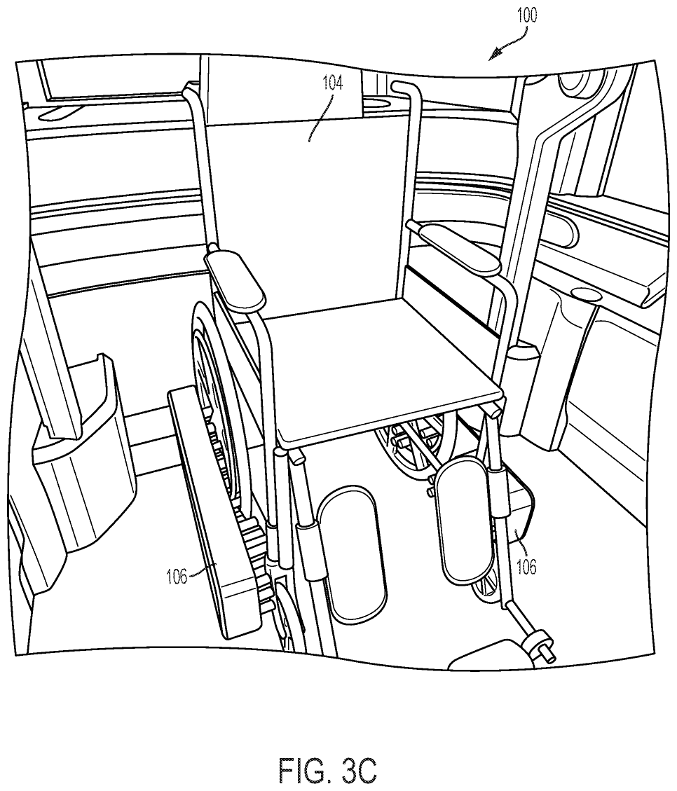

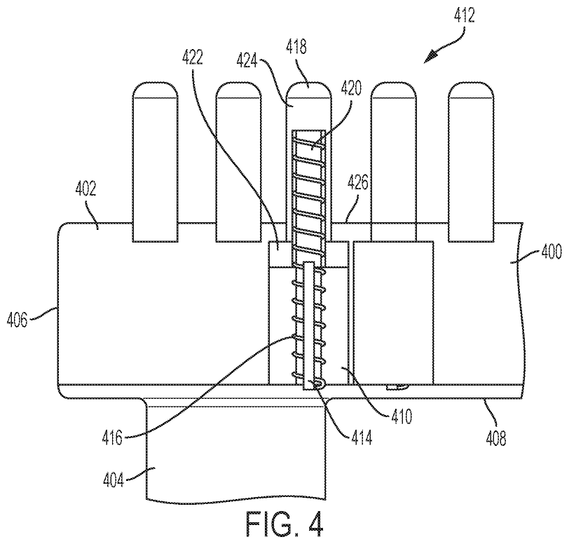

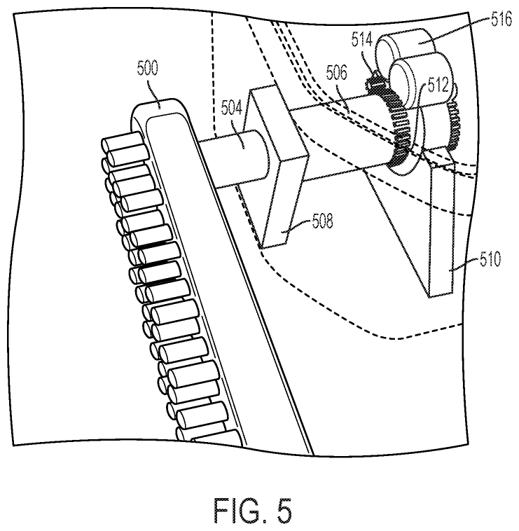

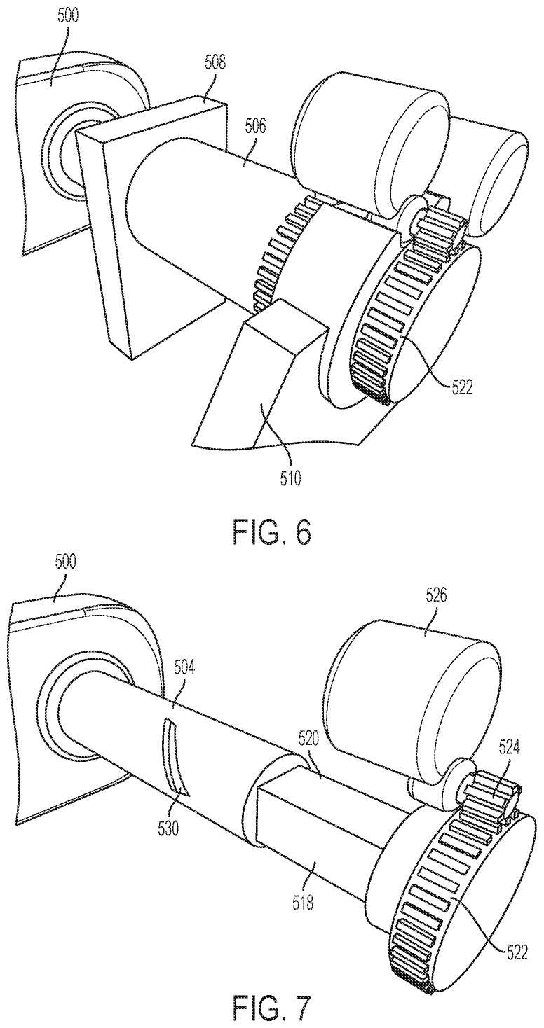

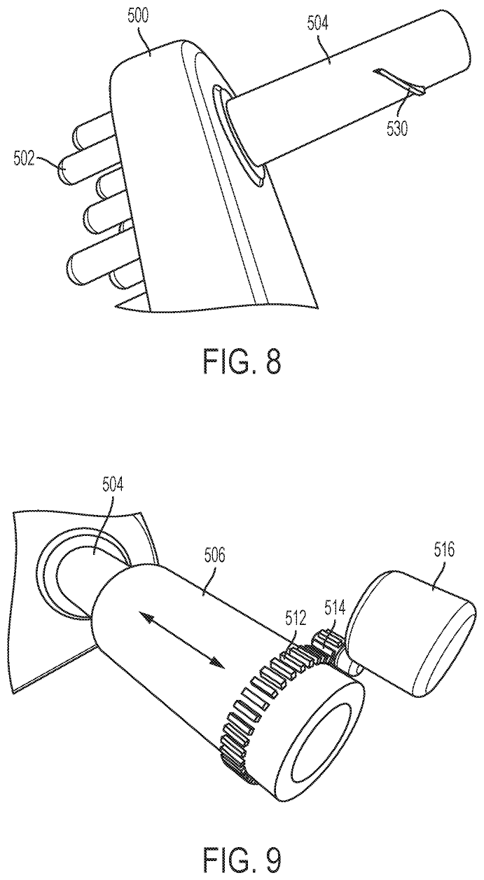

FIGS. 5-10 provide perspective views of an exemplary wheelchair securing system in accordance with present disclosure. An arm 500 having a plurality of fingers 502 is attached to a shaft 504. The shaft 504 is able to extend inwardly to enable the arm 500 to come into contact with a wheelchair and apply a compressive force to the wheelchair. The shaft 504 is slidably mounted on a square cross-section portion 520 of a rotator shaft 518. The rotator shaft 518 includes a set of external teeth 522 that engage with a first pinion 524 that is driven by a first motor 526. Selective activation of the first motor 526 causes the first pinion 524 to rotate which, in turn, causes the rotator shaft 518 and the shaft 504 to rotate. In this manner, the shaft 504 is able to rotate about its axis to enable the arm 500 to pivot between vertical and horizontal orientations in a manner similar to that described previously with reference to FIGS. 3A-3C.

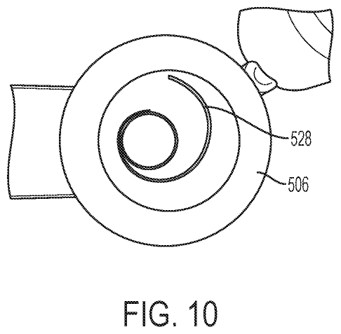

The shaft 504 is also received within a cylinder 506. The cylinder 506 is rotationally supported by a first bearing 508 and a second bearing 510. The cylinder 506 includes a plurality of gear teeth 512 that mesh with a pinion gear 514 that is driven by a second motor 516. As illustrated in FIG. 10, the internal surface of the cylinder includes a helical slot 528 which receives a helical ridge 530 on the external surface of the shaft 504. Selective activation of the second motor 516 results in the second pinion 514 causing rotation of the cylinder 506 within the bearings 508 and 510. Since the rotation of the shaft 504 is independently controlled by the rotator shaft 518, rotation of the cylinder 506 and the engagement of the helical ridge 530 in the helical slot 528 causes the shaft 504 to translate along the axis toward the wheelchair or away from the wheelchair, depending upon the direction of rotation of the cylinder 506. In this manner, selective activation and control of the first motor 526 and the second motor 516 enables separate and independent control over the rotation of the arm 500 between the vertical and horizontal orientations and the movement of the arm 500 toward or away from the side of a wheelchair.

While this detailed description discloses a specific exemplary structure and method for causing the arm to selectively and independently rotate and/or to extend inwardly or outwardly, it is to be understood that there may be multiple other structures that may enable the same function(s). The present disclosure is not limited to any specific means of providing rotation and/or extension/retraction of the arm(s).

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A wheelchair securing system for a passenger vehicle, the system comprising:
a first lateral barrier positioned on one side of a wheelchair receiving area of the passenger vehicle; and
a second lateral barrier positioned on an opposing side of the wheelchair receiving area, wherein each of the first and second lateral barriers are adapted to compressively engage a wheelchair between them, and wherein the first lateral barrier includes a plurality of fingers extending from a surface of the first lateral barrier toward the wheelchair receiving area.

2. The system of claim 1, wherein one of the plurality of fingers adaptively configure the distance that the one of the plurality of fingers extends from the surface of the first lateral barrier.

3. The system of claim 2, wherein the distance that the one of the plurality of fingers extends from the surface of the first lateral barrier is responsive to contact with a wheelchair.

4. The system of claim 3, wherein the one of the plurality of fingers reduces the extent that the one of the plurality of fingers extends from the surface of the first lateral barrier in response to contact with the wheelchair.

5. The system of claim 4, wherein another one of the plurality of fingers maintains the extent that the another one of the plurality of fingers extends from the surface of the first lateral barrier in response to an absence of contact with the wheelchair.

6. The system of claim 2, wherein the first lateral barrier comprises an arm body defining a cavity adapted to slidably receive the one of the plurality of fingers.

7. The system of claim 6, further comprising a spring in the cavity biasing the one of the plurality of fingers to extend out of the surface of the first lateral barrier.

8. The system of claim 6, wherein the arm body further includes an orifice at the surface having a smaller diameter than a diameter of the cavity.

9. The system of claim 8, wherein the one of the plurality of fingers comprises a protrusion and a cylindrical base.

10. The system of claim 9, wherein the diameter of the orifice is smaller than a diameter of the cylindrical base and is larger than a diameter of the protrusion.

11. A passenger vehicle with a wheelchair securing system, the vehicle comprising:
a first lateral barrier positioned on one side of a wheelchair receiving area of the passenger vehicle; and
a second lateral barrier positioned on an opposing side of the wheelchair receiving area, wherein each of the first and second lateral barriers are adapted to compressively engage a wheelchair between them, and wherein the first lateral barrier includes a plurality of fingers extending from a surface of the first lateral barrier toward the wheelchair receiving area.

12. The vehicle of claim 1, wherein one of the plurality of fingers adaptively configure the distance that the one of the plurality of fingers extends from the surface of the first lateral barrier.

13. The vehicle of claim 2, wherein the distance that the one of the plurality of fingers extends from the surface of the first lateral barrier is responsive to contact with a wheelchair.

14. The vehicle of claim 3, wherein the one of the plurality of fingers reduces the extent that the one of the plurality of fingers extends from the surface of the first lateral barrier in response to contact with the wheelchair.

15. The vehicle of claim 4, wherein another one of the plurality of fingers maintains the extent that the another one of the plurality of fingers extends from the surface of the first lateral barrier in response to an absence of contact with the wheelchair.

16. The vehicle of claim 2, wherein the first lateral barrier comprises an arm body defining a cavity adapted to slidably receive the one of the plurality of fingers.

17. The vehicle of claim 6, further comprising a spring in the cavity biasing the one of the plurality of fingers to extend out of the surface of the first lateral barrier.

18. The vehicle of claim 6, wherein the arm body further includes an orifice at the surface having a smaller diameter than a diameter of the cavity.

19. The vehicle of claim 8, wherein the one of the plurality of fingers comprises a protrusion and a cylindrical base.

20. The vehicle of claim 9, wherein the diameter of the orifice is smaller than a diameter of the cylindrical base and is larger than a diameter of the protrusion.
